(19) United States
(12) Patent Application Publication
(10) Pub. No.: US 2005/0131968 A1
(43) Pub. Date: Jun. 16, 2005

(54) Method for performing verifications on backup data within a computer system

(75) Inventor: Oliver Augenstein, Dettenhausen (DE)

Correspondence Address: DILLION & YUDELL, LLP, 8911 N CAPITAL OF TEXAS HWY, SUITE 2110, AUSTIN, TX, 78759, US

(73) Assignee: International Business Machines Corporation, Armonk, NY (US)

(21) Appl. No.: 10/976,221

(22) Filed: Oct. 26, 2004

(30) Foreign Application Priority Data
Dec. 12, 2003 (DE) 03104676.6

(51) Int. Cl. G06F 17/30

(52) U.S. Cl. 707/204

(57) ABSTRACT

A method for performing verifications on backup data within a computer system is disclosed. Initially, a data volume is divided into multiple data groups. A backup operation is performed on all of the data groups on a periodic basis. After the performance of a backup operation in each period, the integrity of a subset of the data groups is verified such that data in all of the data groups are eventually verified.

### BACKGROUND OF THE INVENTION

1. Technical Field

The present invention relates to computer systems in general, and, in particular, to data backup within a computer system. Still more particularly, the present invention relates to a method for performing verifications on backup data within a computer system.

2. Description of Related Art

In order to protect against data loss, data in computer systems are commonly backed up on magnetic media on regular basis. Most of the backup methodologies require interactive responses and physical presence of a human being. But there are some backup methodologies that are capable of automatically storing and restoring data in a computer system by employing auxiliary storage pools associated with at least one computer system in a multiple computer system environment.

Since the backup time for large computer systems may require many hours to complete, data backup on large computer systems are seldom performed on a daily basis. For example, some large computer systems implement an incremental dumping policy in which a complete data dump is performed on a weekly or monthly basis, and a partial data dump is performed daily but only on those files that have been modified since the previous complete data dump.

Because of the voluminous size of data being backed up, it is not always possible to guarantee that the data stored on a backup data storage medium correspond to their original data. However, the verification process for the large amount of data is also very time-consuming. Thus, it would be desirable to provide an improved method for verifying the integrity of the backup data after the performance of a data backup.

### SUMMARY OF THE INVENTION

In accordance with a preferred embodiment of the present invention, a data volume is initially divided into multiple data groups. A backup operation is performed on all of the data groups on a periodic basis. After the performance of a backup operation in each period, the integrity of a subset of the data groups is verified such that data in all of the data groups are eventually verified.

All features and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 is a high-level logic flow diagram of a method for performing verifications on backup data within a computer system, in accordance with a preferred embodiment of the present invention; and

FIG. 2 illustrates a data volume on which backup operations can be performed in accordance with a preferred embodiment of the present invention.

### DETAILED DESCRIPTION OF A PREFERRED EMBODIMENT

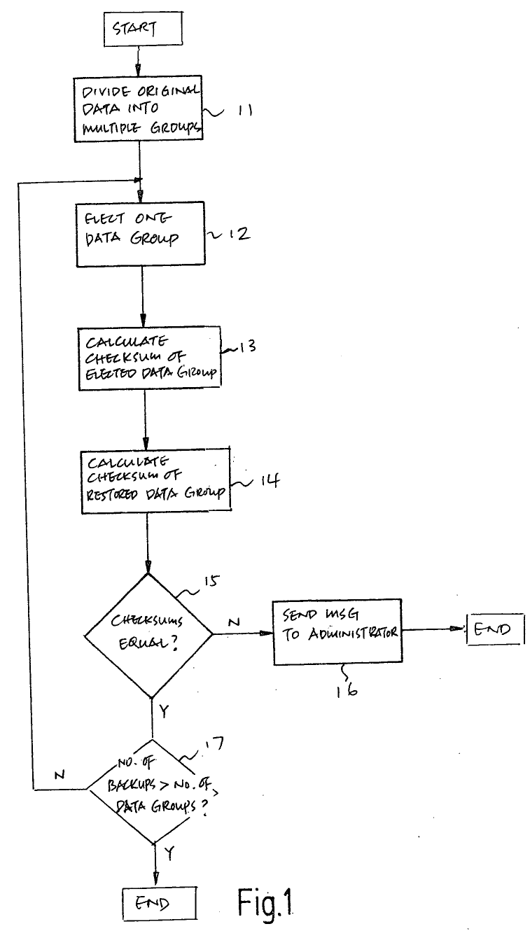

Referring now to the drawings and in particular to FIG. 1, there is illustrated a high-level logic flow diagram of a method for performing verifications on backup data within a computer system, in accordance with a preferred embodiment of the present invention. The original data within a database to be backed up may include a list of files. The original data are to be stored in a separate backup storage medium. During the performance of data backup, the original data are divided into multiple data groups (or multiple corresponding file groups), as shown in block 11. Next, one data group (or one file group) is elected from the original data groups, as depicted in block 12. The checksum of the elected data group is calculated, as shown in block 13. The same elected data group in the backup storage medium is then virtually restored (i.e., read) from the backup storage medium, and the checksum of the virtually restored data group is calculated, as depicted in block 14.

Subsequently, a determination is made as to whether or not the checksum of the virtually restored data group is identical to the checksum of the original data group in order to verify the integrity of the backup data for the elected data group, as shown in block 15. If the checksum of the virtually restored data group does not correspond to the checksum of the elected data group, a message is sent to an administrator indicating such, as depicted in block 16. Otherwise, if the checksum of the virtually restored data group is identical to the checksum of the elected data group, the steps shown in block 12 to block 15 are repeated until the number of backups has reached the number of data groups formed in block 11, as shown in block 17.

For example, a large data volume can be divided into 10 partitions. During the performance of a backup operation, only one of the 10 partitions is verified so that after 10 backup operations, all 10 partitions are verified. In order to verify the validity of the data backup, only the partial data volumes or data groups CRC checksums are calculated. In case of a necessary restore of the entire data volume, different partial backup volumes can be linked in order to reveal the entire volume.

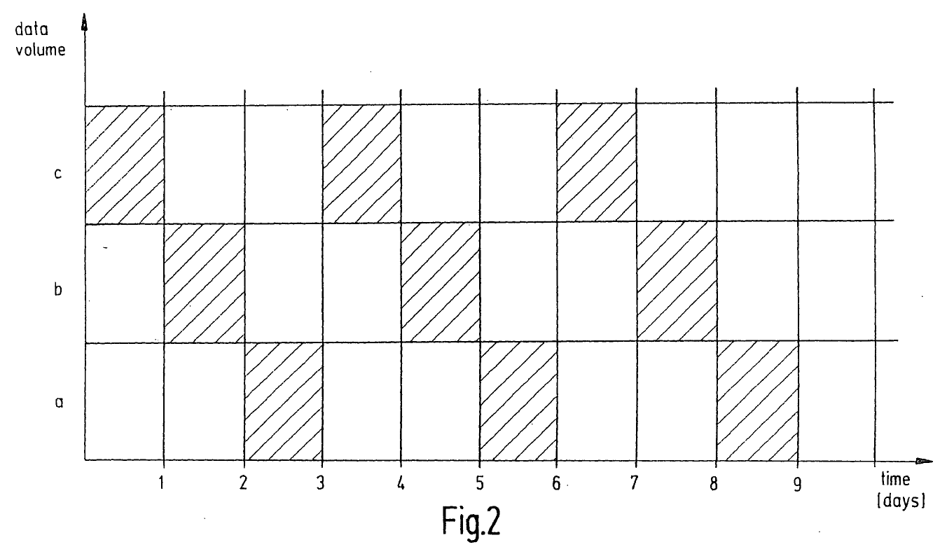

The method of the present invention can also be illustrated by way of a data volume shown in FIG. 2. With reference now to FIG. 2, there is depicted a data volume on which backup operations can be performed in accordance with a preferred embodiment of the present invention. As shown, an entire data volume is divided into three partitions (or data groups), namely, a partition a, a partition b and a partition c. At the end of a first day, a first backup operation is performed on the entire data volume but only the data in partition c is verified. At the end of a second day, a second backup operation is performed on the entire data volume but only the data in partition b is verified. At the end of a third day, a third backup operation is performed on the entire data volume but only the data in partition a is verified. As such, all data in partitions a-c of the data volume are verified every three days. Alternatively, it is also possible to backup data in only one of partitions a-c and not the entire data volume in each backup operation.

As has been described, the present invention provides a method and system for performing verifications on backup data. Because it is very time-consuming to verify the validity of all backup data by calculating and comparing checksums, the backup verification method of the present invention provides the advantage of only verifying a small portion of a large data volume during a backup operation.

Although the present invention has been described in the context of a fully functional computer system, those skilled in the art will appreciate that the mechanisms of the present invention are capable of being distributed as a program product in a variety of forms, and that the present invention applies equally regardless of the particular type of signal bearing media utilized to actually carry out the distribution. Examples of signal bearing media include, without limitation, recordable type media such as floppy disks or CD ROMs and transmission type media such as analog or digital communications links.

While the invention has been particularly shown and described with reference to a preferred embodiment, it will be understood by those skilled in the art that various changes in form and detail may be made therein without departing from the spirit and scope of the invention.

1. A method for performing verifications on backup data on a backup data storage system, said method comprising:
dividing a data volume into a plurality of data groups;
performing a backup operation on said plurality of data groups on a periodic basis; and
verifying the integrity of a subset of said plurality of data groups after the performance of a backup operation in each period, such that data in all of said plurality of data groups are eventually verified.

2. The method of claim 1, wherein said performing a backup operation further includes
electing one of said plurality of data groups;
determining a checksum for said elected data group;
virtually restoring a backup of said elected data group; and
determining a checksum of said virtually restored backup.

3. The method of claim 1, wherein said verifying further includes comparing said checksum of said elected data group to said checksum of said virtually restored backup.

4. The method of claim 1, wherein method further includes sending a message to a system administrator if said checksum of said virtually restored backup does not correspond with said checksum of said elected data group.

5. The method of claim 1, wherein said subset is one.

6. The method of claim 1, wherein data in all of said plurality of data groups are verified when the number of backup operations equals the number of said plurality of data groups.

7. A computer program product residing on a computer usable medium for performing verifications on backup data on a backup data storage system, said computer program product comprising:
program code means for dividing a data volume into a plurality of data groups;
program code means for performing a backup operation on said plurality of data groups on a periodic basis; and
program code means for verifying the integrity of a subset of said plurality of data groups after the performance of a backup operation in each period, such that data in all of said plurality of data groups are eventually verified.

8. The computer program product of claim 7, wherein said program code means for performing a backup operation further includes
program code means for electing one of said plurality of data groups;
program code means for determining a checksum for said elected data group;
program code means for virtually restoring a backup of said elected data group; and
program code means for determining a checksum of said virtually restored backup.

9. The computer program product of claim 7, wherein said program code means for verifying further includes program code means for comparing said checksum of said elected data group to said checksum of said virtually restored backup.

10. The computer program product of claim 7, wherein computer program product further includes program code means for sending a message to a system administrator if said checksum of said virtually restored backup does not correspond with said checksum of said elected data group.

11. The computer program product of claim 7, wherein said subset is one.

12. The computer program product of claim 1, wherein data in all of said plurality of data groups are verified when the number of backup operations equals the number of said plurality of data groups.

13. An apparatus for performing verifications on backup data on a backup data storage system, said apparatus comprising:
means for dividing a data volume into a plurality of data groups;
means for performing a backup operation on said plurality of data groups on a periodic basis; and
means for verifying the integrity of a subset of said plurality of data groups after the performance of a backup operation in each period, such that data in all of said plurality of data groups are eventually verified.

14. The apparatus of claim 13, wherein said program code means for performing a backup operation further includes
means for electing one of said plurality of data groups;
means for determining a checksum for said elected data group;
means for virtually restoring a backup of said elected data group; and
means for determining a checksum of said virtually restored backup.

15. The apparatus of claim 13, wherein said means for verifying further includes means for comparing said checksum of said elected data group to said checksum of said virtually restored backup.

16. The apparatus of claim 13, wherein apparatus further includes means for sending a message to a system administrator if said checksum of said virtually restored backup does not correspond with said checksum of said elected data group.

17. The apparatus of claim 13, wherein said subset is one.

18. The apparatus of claim 1, wherein data in all of said plurality of data groups are verified when the number of backup operations equals the number of said plurality of data groups.
